(19) United States
(12) Patent Application Publication
(10) Pub. No.: US 2025/0368920 A1
(43) Pub. Date: Dec. 4, 2025

(54) REMOVAL OF IMPURITIES FROM TALL OIL FEED BY SOLVENT PRECIPITATION

(71) Applicant: Neste Oyj, Espoo (FI)

(72) Inventors: Kirsi SALORINNE, Porvoo (FI); Kaisa LAMMINPÄÄ, Porvoo (FI); Meri HOVI, Porvoo (FI); Rami PIILOLA, Porvoo (FI); Werner GOLDMANN VALDES, Porvoo (FI)

(73) Assignee: Neste Oyj, Espoo (FI)

(21) Appl. No.: 18/876,317

(22) PCT Filed: Jun. 29, 2023
(86) PCT No.: PCT/FI2023/050406

§ 371 Date: Dec. 18, 2024

(30) Foreign Application Priority Data
Jun. 30, 2022 (FI) 20225611

(51) Int. Cl. C11C 3/12; B01D 11/04; C11C 3/00

(52) U.S. Cl. CPC C11C 3/12; B01D 11/0488; B01D 11/0492; C11C 3/00

(57) ABSTRACT

A method for the purification of impurities from tall oil feed, and a corresponding liquid product obtained by the method, is provided includes mixing the tall oil feed with an added solvent, removing impurities that precipitate when the solvent is added, and then recovering a liquid product as a tall oil feed with a reduced impurity content.

### TECHNICAL FIELD

The present disclosure generally relates to processing of tall oil feed. The disclosure relates particularly, though not exclusively, to a process for removing impurities from tall oil feed by solvent precipitation to obtain purified tall oil feed.

### BACKGROUND

This section illustrates useful background information without admission of any technique described herein being representative of the state of the art.

Tall oil feeds such as crude tall oil (CTO) and its derivatives, such as tall oil pitch (TOP), crude fatty acid (CFA), tall oil fatty acid (TOFA) and distilled tall oil (DTO) contain a variety of impurities which are detrimental to processing of tall oil feeds. These impurities are typically metals (including sodium, potassium, and iron), metalloids (silicon), and non-metals (phosphorus, nitrogen, sulphur, and chlorine), and they make utilization of tall oil feeds in chemical industry difficult and costly.

There is therefore a need to develop purification methods that at least partially alleviate the above problems. Additionally, there is a need for renewable carbonaceous products that can be further converted to fuels and/or be used in chemical industry.

### SUMMARY

The appended claims define the scope of protection. Any example or description of an apparatus, system, product, or process in the description, claim, and/or drawing which is not covered by the claims, is presented herein not as an embodiment of the invention but as background art or as an example useful for understanding the invention.

According to a first aspect is provided a method for removing impurities from a tall oil feed, comprising:
a. a step of adding to the tall oil feed a solvent comprising C3-C18 paraffins, preferably C3-C7 paraffins, to obtain a mixture, and
b. a separating step comprising separating from the mixture at least a solid precipitate and a liquid phase;
   and wherein the method further comprises bleaching at least one of: the tall oil feed, the mixture, and the liquid phase.

In the present method the solvent is added to the tall oil feed to provide a mixture, which forms a precipitate containing impurities. The precipitate, and the impurities contained in it, is then separated from the mixture to provide purified tall oil feed as the liquid phase. Separation of the solid precipitate can be achieved for example by filtering. The present method is thus simple to perform at an industrial scale and it is suitable for being integrated to existing production processes.

The present method prevents, or at least reduces, a need for pre-treatment of tall oil feeds, such as heat treatment and/or bleaching that are energy intensive methods and involve using large amounts of reagents. This present method can also reduce the amount of bleaching agents used in bleaching.

The present solvent is inert in the method, and it is not significantly consumed. In an embodiment the solvent is recycled in the method. The solvent can be separated from the purified tall oil feed, or from the liquid phase, by distillation. A solvent comprising C3-C7 paraffins is preferred due to their easier separation in step b, or from the liquid phase.

Another advantage of the present method is that as impurities are removed, catalyst life-time in downstream processing of the purified tall oil feed is increased.

Advantageously the present method is able to remove impurities that otherwise would block or deactivate catalysts that are typically used in chemical conversion of tall oil feeds.

Another advantage is that use of water, which has been used in previous purification methods, can be avoided thereby providing environmental benefits in reduced wastewater generation. This also makes the present suitable for removing water-soluble impurities, allowing more diversity in the tall oil feed source.

Impurities purified by the present method are precipitated as the solid precipitate.

The present method is particularly effective in removing element impurities. Element impurities are elements which are problematic for the function and longevity of the catalyst, as well as increasing the fouling of the process. Examples of element impurities are metal impurities. Another example of element impurities are metalloid impurities. Further examples of element impurities are elements shown in Table 1 and/or Table 2. A further impurity removed by the present method is lignin.

In an embodiment the present method further comprises hydrodeoxygenating the liquid phase obtained in step b. to obtain a hydrodeoxygenated product, and at least partially recycling the hydrodeoxygenated product to step a., and wherein the temperature during step a. does not exceed 100° C. It is preferable to keep the temperature below 150° C., and/or below 100° C., to at least partially prevent formation of agglomerates.

In an embodiment in the present method the tall oil feed comprises at least one of crude tall oil (CTO) and its derivatives, such as tall oil pitch (TOP), crude fatty acid (CFA), tall oil fatty acid (TOFA) and distilled tall oil (DTO). In an embodiment in the present method the tall oil feed comprises at least one of crude tall oil (CTO) and tall oil pitch (TOP). In another embodiment the tall oil feed is crude tall oil, tall oil pitch, or their mixture.

In an embodiment the tall oil feed contains less than 25 wt-%, less than 24 wt-%, less than 23 wt-%, less than 22 wt-%, less than 21 wt-%, or less than 20 wt-% fatty acids. In another embodiment the tall oil feed contains less than 22 wt-%, less than 20 wt-%, less than 18 wt-%, less than 16 wt-%, less than 14 wt-%, less than 12 wt-%, or less than 10 wt-% fatty acids.

In an embodiment the tall oil feed does not contain animal fats.

Crude tall oil (CTO) is typically obtained as a by-product of the Kraft process (wood pulping). CTO comprises resin acids, fatty acids, and unsaponifiables. Resin acids are a mixture of organic acids derived from oxidation and polymerization reactions of terpenes. Fatty acids are long chain monocarboxylic acids and are found in hardwoods and softwoods. Unsaponifiables cannot be turned into soaps as they are neutral compounds which do not react with sodium hydroxide to form salts.

The term “tall oil pitch (TOP)” refers to residual bottom fraction from crude tall oil (CTO) distillation processes. Tall oil pitch typically comprises from 34 to 51 wt % free organic acids, from 23 to 37 wt % esterified organic acids, and from 25 to 34 wt % unsaponifiable neutral compounds of the total weight of the tall oil pitch. Said organic acids (free and esterified) are typically carboxylic acids, primarily fatty acids and rosin acids.

The term “crude fatty acid (CFA)” refers to fatty acid-containing materials obtainable by purification (e.g., distillation under reduced pressure, extraction, and/or crystallization) of CTO.

The term “tall oil fatty acid (TOFA)” refers to fatty acid rich fraction of crude tall oil (CTO) distillation processes. TOFA typically comprises mainly fatty acids, typically at least 80 wt % of the total weight of the TOFA. Typically, TOFA comprises less than 20 wt % rosin acids.

The term “distilled tall oil (DTO)” refers to resin acid rich fraction of crude tall oil (CTO) distillation processes. DTO typically comprises mainly fatty acids, typically from 55 to 90 wt %, and rosin acids, typically from 10 to 40 wt % rosin acids, of the total weight of the DTO. Typically, DTO comprises less than 10 wt % unsaponifiable neutral compounds of the total weight of the distilled tall oil.

In an embodiment in the present method the mass ratio of the tall oil feed to the added solvent is selected from the range 1:2 to 2:1, or from 1:2 to 1:1, or from 1:1 to 1:2. In another embodiment the mass ratio of the tall oil feed to the added solvent is selected from the range 1:3 to 3:1, or from 1:3 to 2:1, from 1:3 to 1:1, or from 1:3 to 1:2, or from 3:1 to 2:1, from 3:1 to 1:1, or from 3:3 to 1:2, or from 3:3 to 1:3. Using less solvent is preferable to achieve lower total flow rates for the same mass of tall oil feed. Additionally, a lower amount of solvent can mean higher viscosity of the mixture, and a higher amount of solvent may be useful to reduce the viscosity of the mixture.

In an embodiment the present method is a continuous process further comprising recovering from the liquid phase C3-C18 hydrocarbons, preferably C3-C7 hydrocarbons, and at least partially recycling them in the solvent added in step a. Advantageously, when the method is running as a continuous process, the solvent which is needed in the purification can be produced by the method itself, and therefore no additional solvent is necessarily fed into the process when the process is running in continuous mode. In another embodiment the solvent with C3-C18 and/or C3-C7 hydrocarbons are added into the continuous process at least when the process is started. Recycling of the solvent allows to control the amount of the tall oil feed to the added solvent, making it easy to adjust the purification method to tall oil feeds with varying impurities.

In an embodiment the present method is a continuous process comprising hydrodeoxygenating the liquid phase obtained in step b. to obtain a hydrodeoxygenated product, recovering from the hydrodeoxygenated product C3-C18 hydrocarbons, preferably C3-C7 hydrocarbons, and at least partially recycling them to step a.

In an embodiment the present method is carried out such that temperature does not exceed 100° C. during step a. or b, and optionally during the bleaching.

In an embodiment the present method is carried out such that temperature does not exceed 50° C. during step a. or b, and optionally during the bleaching. This embodiment is useful when not using recycled HDO product. A high impurity tall oil feed can in this case be directly mixed with the solvent.

In an embodiment in the present method the bleaching comprises bleaching with an acid, preferably bleaching the liquid phase with an acid solution and an adsorbent such as bleaching earth e.g. bentonite or bleaching clay e.g. hydrated aluminum silicates.

The term “acid” is intended to mean any type of acid or substance chemically classified as an acid. The acid may be an organic or inorganic acid. The acid may further be a mono-, di-, tri-, or tetra-acid having one or more acid functional groups. Some non-limiting examples may be e.g. citric acid, oxalic acid, malic acid, malonic acid, succinic acid, glutaric acid, adipic acid, maleic acid, ethylenediaminetetraacetic acid (EDTA), phosphoric acid, sulphuric acid or the likes in any suitable concentration.

In an embodiment in the present method the solid precipitate is further washed with the solvent used in step a., preferably with C3-C7 paraffins, more preferably with pentane. With this embodiment oil loss can be prevented at least partially, resulting into higher carbon efficiency of the method.

In an embodiment where the solid precipitate is washed with the solvent used in step a., the washing means that the washing is carried out using a paraffin mixture containing the same hydrocarbons as the solvent. For example, when the solvent comprises C3-C18, or C3-C7, paraffins, the solid precipitate is washed with C3-C18, or C3-C7, paraffins, respectively. It is clear to the skilled person that when a reference is made to the solvent used in step a., this refers to the similarity in the paraffinic composition of the solvent and the paraffin mixture used in the washing. For example, when solvent is at least partially recycled after hydrodeoxygenation and used in step a. as the solvent, this recycled solvent can be used to wash the solid precipitate. However, the skilled person understands that the solvent used in the washing of the precipitate does not need to be directly obtained in the present method, and a hydrocarbon mixture having the same or similar carbon number composition as the solvent can also be used instead. Preferably, the carbon number distribution of the solvent used in the washing is, however, narrower than the carbon number distribution of the liquid product or the solvent used in step a. to obtain a mixture.

In an embodiment the present method further comprises recycling in step a. a washing effluent obtained from the wash with the solvent. This embodiment is useful to recover from the solid precipitate carbonaceous components, while simultaneously keeping the amount of impurities in the liquid product controlled to a low level.

In an embodiment the present method further comprises a filtering step, wherein the mixture is filtered through an about 1-10 μm filter, preferably an about 5 μm filter. In an embodiment the filtering step is used as the separation step b.

It was surprisingly found that impurities could be removed by a filtering step in which the mixture obtained in step a. of the present method is filtered through a filter.

Previously filtering of tall oil feed has not been feasible because of their high viscosity, which makes filtration too slow for practical purposes. This problem has been attempted to be solved by increasing temperature to better control viscosity of tall oil feeds, but this results into increased solubility of impurities and failure to remove impurities in an efficient way.

In an embodiment the liquid product is filtered through a filter. This embodiment is useful in case an even higher purity of the tall oil feed containing liquid product is needed after removal of the solid precipitate. The use of solvent in the present method lowers the viscosity to a level which makes it possible to pass the liquid product through a filter without raising the temperature a level which dissolves impurities.

According to a second aspect is provided a liquid phase obtained by the present method. The present liquid product has decreased impurity content compared to the tall oil feed which is fed into the present method. With the present method the resulting liquid phase, which comprises purified tall oil feed and solvent, is chemically and physically different compared to the tall oil feed used as the starting material. The liquid phase does not contain impurities removed with the precipitate in step b, and the impurity content is much reduced, as evidenced by the results shown in the Examples.

In an embodiment the liquid phase has an at least 40% lower metal element content than the tall oil feed.

In an embodiment the liquid phase has an at least 40% lower Fe content than the tall oil feed.

### BRIEF DESCRIPTION OF THE FIGURES

Some example embodiments will be described with reference to the accompanying figures, in which:

FIG. 1 shows a schematic figure of an embodiment of the present process.

FIG. 2 shows a schematic figure of an embodiment of the present process involving a HDO step and recycling of the HDO product as a solvent.

### DETAILED DESCRIPTION

As used herein, the term “comprising” includes the broader meanings of “including”, “containing”, and “comprehending”, as well as the narrower expressions “consisting of” and “consisting only of”.

In an embodiment the method steps are carried out in the sequence identified in any aspect, embodiment, or claim. In another embodiment any method step specified to be carried out to a product or an intermediate obtained in a preceding step is carried out directly to said product or intermediate, i.e. without additional, optional or auxiliary processing steps that may chemically and/or physically alter the product or intermediate between said two consecutive steps.

In an embodiment the present process is an industrial process. In another embodiment the industrial process may exclude small scale methods such as laboratory scale methods that are not scaled up to volumes used in industry.

In an embodiment the present process is a continuous process.

In an embodiment the boiling point refers to a boiling point at atmospheric pressure.

In an embodiment the pressure and the temperature used in the present method are selected such that at least the solvent remains in liquid phase during the method, excluding an optional distillation step to separate the solvent for recycling in the process or for other purposes.

In an embodiment the pressure is selected from the range 1-50 bar.

In an embodiment the temperature is selected from the range 20-100° C.

In an embodiment the temperature does not exceed 50° C. This embodiment is useful for keeping the solubility of the impurities at a minimal level.

In an embodiment the temperature does not exceed 100° C. This embodiment is useful when carrying out hydrodeoxygenation (HDO) to the purified tall oil feed, i.e. to the liquid phase obtained in the present method.

In an embodiment the liquid phase is hydrodeoxygenated.

In an embodiment the hydrodeoxygenation is carried out catalytically, preferably by a NiMo catalyst, more preferably with a NiMo/CoMo catalyst, more preferably with a NiMo+Alumina/CoMo+Alumina catalyst.

In an embodiment the hydrodeoxygenation is carried out at a temperature selected from the range 290-360° C.

In an embodiment the hydrodeoxygenation is carried out at a pressure selected from the range 30-150 bar.

In an embodiment the hydrodeoxygenation is carried out a weight hourly space velocity (WHSV) of 0.1-3.

In an embodiment the hydrodeoxygenation is carried out at a volume ratio of hydrogen to hydrocarbon of 500-1500.

In an embodiment the hydrodeoxygenated product has a boiling point in the range 180-650° C.

In an embodiment the hydrodeoxygenated product comprises 30-80 wt-% paraffins.

In an embodiment the hydrodeoxygenated product comprises 10-40 wt-% naphthenes.

In an embodiment the hydrodeoxygenated product comprises 2-20 wt-% aromatics.

In an embodiment the solvent comprising C3-C18 paraffins comprises each of said paraffins. The amount of individual paraffins having a certain carbon number in the solvent may vary, and the amount of e.g. C3 paraffins (in mole, mass or volume units) is not necessarily the same as the amount of C18 paraffins in the solvent.

In an embodiment the solvent comprises at least one paraffin having its carbon number in the range C3-C18. A preferable example of such a solvent is a solvent comprising or consisting of pentane. Another example is a solvent comprising pentane and at least one further paraffin having its carbon number in the range C3-C7.

In an embodiment the solvent comprises C3-C7 hydrocarbons, preferably C3-C7 paraffins. Preferably in this embodiment the temperature is selected from the range 20-50° C. In a more preferable embodiment no hydrodeoxygenated product is recycled as a solvent when using this temperature range.

In an embodiment the solvent comprising C3-C18 paraffins, or C3-C7 paraffins, contains each of the paraffins falling within this carbon number range.

The use of the solvent allows separating impurities from the mixture. In an embodiment the solvent does not significantly increase solubility of impurities.

The solvent can be recycled in the process because the solvent hydrocarbons are compatible with downstream processing of tall oil feeds.

In an embodiment the separating step does not involve using a filtering aid which is typically comprised of a solid material such as cellulose or chemical pulp. This has an advantage of reducing the size of the filtering cake and, correspondingly, the amount of waste. Additionally, washing of the filtering cake or a solid precipitate obtained in the separating step is more efficient because the filtering cake is smaller, resulting into a higher carbon efficiency of the method.

In an embodiment the tall oil feed is not washed with water in the method.

In an embodiment the liquid phase obtained in the separating step is not washed with water.

The term purified tall oil feed refers herein to the product obtained by the present method after impurities have been removed from the tall oil feed. The purified tall oil feed is also called the liquid phase.

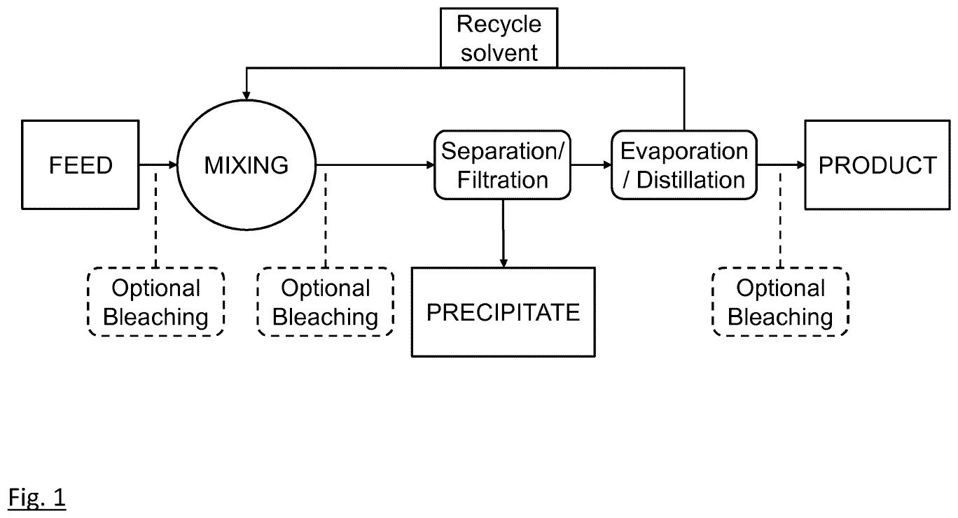

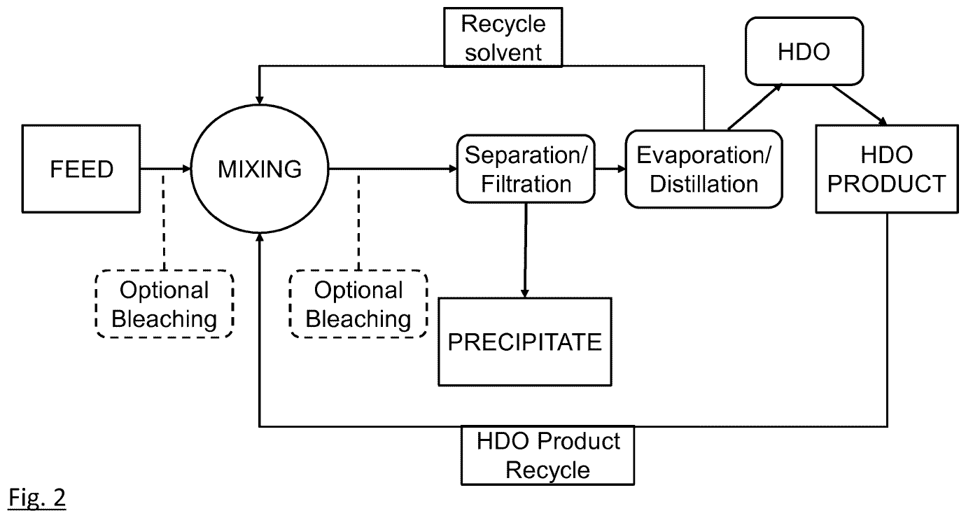

The bleaching step can be carried out to any, some, or each of the products specified in the present method, as is also illustrated in FIG. 1 and FIG. 2.

In an embodiment the bleaching is carried out by mixing a feed containing tall oil feed with an acid, such as citric acid or phosphoric acid or malic acid, and bleaching earth.

In an embodiment bleaching is carried out directly to the tall oil feed before mixing with the solvent.

In an embodiment bleaching is carried out to mixture obtained by mixing the tall oil feed with the solvent.

In an embodiment bleaching is carried out on the liquid phase.

The present method efficiently removes impurities from the tall oil feed, as shown in the Examples below. Removal of impurities was confirmed by chemical analysis which revealed that at least 40% of the impurities was successfully removed. In the context of tall oil feed impurities all percentage values refer to weight-%, and typically impurities of tall oil feeds are expressed as mg/kg.

In an embodiment the present method removes at least 30 wt-% of tall oil feed impurities from the tall oil feed.

In an embodiment the present method removes at least 40 wt-% of tall oil feed impurities from the tall oil feed.

In an embodiment the present method removes at least 30 wt-% or at least 40 wt-% of metal impurities from the tall oil feed.

In an embodiment the present method removes at least 30 wt % or at least 40 wt-% of metalloid impurities from the tall oil feed.

In an embodiment the present method removes at least 30 wt-% or at least 40 wt-% of inorganic impurities from the tall oil feed.

In an embodiment the tall oil feed impurities comprise at least one of Fe, Na, P, Si, Ca, K, Al, Mn, and Mg.

In an embodiment the tall oil feed impurities comprise Fe, Na, Al, Mn, and Mg, and at least 40 wt-%, at least 50 wt-%, at least 60 wt-%, at least 70 wt-%, at least 80 wt-%, or at least 90 wt-% of these impurities are removed by the present method.

In an embodiment the tall oil feed impurities comprise Fe, P, and Si. At least 30 wt-% or at least 40 wt-% or at least 45 wt-% of these impurities can be removed with the present method.

In an embodiment lignin and/or organic salts are at least partially removed during the present method.

In an embodiment the tall oil feed impurities removed by the present method comprise at least one of Aluminium, Arsenic, Barium, Boron, Cadmium, Calcium, Chromium, Cobalt, Iron, Lithium, Manganese, Molybdenium, Nickel, Phosphorous, Potassium, Silicon, Sodium, Titanium, and Vanadinium. In another embodiment the impurities comprise each of the above elements and at least 30 wt-%, at least 40 wt-% or at least 45 wt-% of these elements are removed by the present method.

As shown in Example 1 below, the present method was able to reduce the amount of element impurities to about 10 mg/kg level. Before mixing with the solvent the tall oil feed was bleached, and it contained about 21 mg/kg of elemental impurities. In an embodiment the present method is used to remove an element impurity specified in Table 1.

In an embodiment the tall oil feed impurities removed by the present method comprise at least one of Na, P, Si, Ca, Fe, K, Al, Mn, Zn, Mg, V, Cr, B, Mo, Ba, Ni, Cu, and Ti. In another embodiment the impurities comprise each of the above elements and at least 30 wt-%, at least 35 wt-% or at least 40 wt-% of these elements are removed by the present method.

As shown in Example 2 below, the present method was able to reduce the amount of element impurities to about 50-60 mg/kg level. The tall oil feed contained about 335 mg/kg of elemental impurities. In an embodiment the present method is used to remove an element impurity specified in Table 2.

In an embodiment lignin and its derivatives forms precipitate that is removed in step b. Removal of lignin has an advantage of reducing the amount of aromatics that may be difficult to remove in downstream processing. By removal of lignin the formation of phenolic compounds can be reduced that are problematic in wastewater treatment. Additionally, a clogging risk associated with lignin precipitation can be avoided in downstream processing of the purified tall oil feed.

In an embodiment at least 50 wt-%, preferably at least 60 wt-%, more preferably at least 70 wt-%, even more preferably at least 80 wt-%, of metals and metalloids are removed in the present method.

In another embodiment the tall oil feed comprises pretreated, such as heat treated, bleached, and/or flashed tall oil feed, and the present method removes at least 30 wt-%, at least 35 wt-%, at least 40 wt-% or at least 45 wt-% of remaining metals and metalloids.

### EXAMPLES

The following examples are provided to better illustrate the claimed invention. They are not to be interpreted as limiting the scope of the invention, which is determined by the claims. To the extent that specific materials are mentioned, it is merely for purposes of illustration and is not intended to limit the invention. One skilled in the art may develop equivalent means or reactants without exercising inventive capacity and without departing from the scope of the invention. It shall be understood that many variations can be made in the procedures described herein while remaining within the scope of the present invention. All exemplary materials and parameters used in the examples below are compatible with the present method and products.

### Example 1: Impurity Removal from Pre-Treated CTO

Pre-treated, including bleaching, CTO was mixed with n-pentane at 25° C. at a ratio of 1:2 (CTO: n-C5). The blend was mixed and the mixture was allowed to settle overnight. The blend was then filtered. The filtrate was separated with 50 mbar vacuum at 100° C. to separate the CTO from the n-pentane. The n-pentane was over 99% pure and could be reused. The CTO mass loss (precipitate) was about 0.7-1.7 wt %. The precipitate contained 40-50% lignin, 1-10% esters, 15-25% fatty acids, and 20-30% resin acids. The CTO from which precipitates had been separated by solvent extraction contained about half of the original metals and metalloids (see Table 1).

TABLE 1
Removal of element impurities from Pre-bleached CTO. The Purified
CTO refers to the amount obtained by the present method.

| Element | | Pretreated | Purified | change | |
|---|---|---|---|---|---|
| Impurity | Unit | CTO | CTO | (mg/kg) | change % |
| Aluminium | mg/kg | 0.3 | 0.2 | 0.1 | 33% |
| Arsenic | mg/kg | 0.0 | 0.0 | 0.0 | 0% |
| Barium | mg/kg | 0.0 | 0.0 | 0.0 | 0% |
| Boron | mg/kg | 0.1 | 0.0 | 0.1 | 100% |
| Cadmium | mg/kg | 0.0 | 0.0 | 0.0 | 0% |
| Calcium | mg/kg | 0.9 | 0.2 | 0.7 | 78% |
| Chromium | mg/kg | 0.1 | 0.0 | 0.1 | 100% |
| Cobalt | mg/kg | 0.0 | 0.0 | 0.0 | 0% |
| Iron | mg/kg | 3.3 | 1.3 | 2.0 | 61% |
| Lithium | mg/kg | 0.0 | 0.0 | 0.0 | 0% |
| Manganese | mg/kg | 0.0 | 0.0 | 0.0 | 0% |
| Molybdenum | mg/kg | 0.0 | 0.0 | 0.0 | 0% |
| Nickel | mg/kg | 0.1 | 0.1 | 0.0 | 0% |
| Phosphorous | mg/kg | 1.1 | 0.6 | 0.5 | 45% |
| Potassium | mg/kg | 0.9 | 0.5 | 0.4 | 44% |
| Silicon | mg/kg | 3.2 | 1.7 | 1.5 | 47% |
| Sodium | mg/kg | 10.5 | 5.3 | 5.2 | 50% |
| Titanium | mg/kg | 0.1 | 0.0 | 0.1 | 100% |
| Vanadium | mg/kg | 0.0 | 0.0 | 0.0 | 0% |
| Sum element | mg/kg | 20.6 | 9.9 | 10.7 | 48% |
| impurities | | | | | |

### Example 2: Impurity removal from untreated CTO

Untreated CTO was mixed with n-pentane at 25° C. at a ratio of at a ratio of 1:2, 1:1, or 2:1 (CTO: n-c5). The blend was mixed and allowed to settle overnight. The mixture was filtered. The filtrate was evaporated at 60° C. The CTO mass loss (precipitate) was about 0.6-2.0 wt %. The precipitate was composed of about 0.08-0.6 wt % metals and metalloids. About 82-87% of the metals and metalloids had been removed from the CTO (see Table 2).

TABLE 2
Removal of element impurities from unbleached CTO with
different solvent ratios expressed as mass/mass ratios.

| Element | | | | | |
|---|---|---|---|---|---|
| Impurity | | | 1 CTO: | 1 CTO: | 2 CTO: |
| (mg/kg) | Unit | CTO | 1 Solvent | 2 Solvent | 1 Solvent |
| Na | mg/kg | 233.4 | 7.6 | 8.6 | 4.9 |
| P | mg/kg | 34.1 | 23.1 | 25.4 | 22.8 |
| Si | mg/kg | 20.6 | 11.8 | 13.2 | 5.7 |
| Ca | mg/kg | 18.0 | 1.3 | 0.4 | 0.3 |
| Fe | mg/kg | 13.8 | 6.7 | 7.1 | 5.9 |
| K | mg/kg | 7.8 | 3.2 | 1.5 | 1.4 |
| Al | mg/kg | 1.9 | 1.0 | 0.6 | 0.4 |
| Mn | mg/kg | 1.6 | 0.1 | 0.1 | 0.0 |
| Zn | mg/kg | 1.0 | 0.2 | 0.2 | 0.1 |
| Mg | mg/kg | 0.8 | 0.1 | 0.1 | 0.1 |
| V | mg/kg | 0.6 | 0.3 | 0.3 | 0.3 |
| Cr | mg/kg | 0.2 | 0.1 | 0.1 | 0.1 |
| B | mg/kg | 0.2 | 0.1 | 0.1 | 0.1 |
| Mo | mg/kg | 0.2 | 0.1 | 0.1 | 0.1 |
| Ba | mg/kg | 0.1 | 0.0 | 0.0 | 0.0 |
| Ni | mg/kg | 0.1 | 0.1 | 0.1 | 0.1 |
| Cu | mg/kg | 0.1 | 0.0 | 0.0 | 0.0 |
| Ti | mg/kg | 0.1 | 0.0 | 0.0 | 0.0 |
| Sum | mg/kg | 334.6 | 55.8 | 57.9 | 42.3 |
| element | | | | | |
| impurities | | | | | |

1-13. (canceled)

14. A method for removing impurities from a tall oil feed, comprising:
a. adding to the tall oil feed a solvent including C3-C18 paraffins to obtain a mixture; and
b. separating from the mixture at least a solid precipitate and a liquid phase;
wherein the method includes bleaching at least one of: the tall oil feed, the mixture, and the liquid phase.

15. The method of claim 14, comprising:
hydrodeoxygenating the liquid phase obtained in step b. to obtain a hydrodeoxygenated product, and at least partially recycling the hydrodeoxygenated product to step a., and wherein a temperature during step a. does not exceed 100° C.

16. The method of claim 14, wherein the tall oil feed comprises:
at least one or more of crude tall oil (CTO), tall oil pitch (TOP), crude fatty acid (CFA), tall oil fatty acid (TOFA) and/or distilled tall oil (DTO).

17. The method of claim 14, wherein the tall oil feed comprises:
at least one or more of crude tall oil (CTO) and/or tall oil pitch (TOP).

18. The method of claim 14, wherein a mass ratio of the tall oil feed to the added solvent is selected from a range 1:2 to 2:1.

19. The method of claim 14, wherein the method is a continuous process comprising:
recovering from the liquid phase C3-C18 hydrocarbons, and at least partially recycling them in the solvent added in step a.

20. The method of claim 14, wherein the method is carried out such that temperature does not exceed 100° C. during step a. or b.

21. The method of claim 14, wherein the bleaching comprises:
bleaching with an acid.

22. The method of claim 14, wherein the solid precipitate is washed with the solvent used in step a.

23. The method of claim 22, comprising:
recycling in step a. a washing effluent obtained from the wash.

24. The method of claim 14, comprising:
a filtering step, wherein the mixture is filtered through a filter of about 1-10 μm.

25. The liquid phase obtained by the method of claim 14.

26. The liquid phase of claim 25, having at least 40% lower metal element content than the tall oil feed.
